(19) United States
(12) Patent Application Publication
(10) Pub. No.: US 2020/0029119 A1
(43) Pub. Date: Jan. 23, 2020

(54) GENERATING MASKS AND DISPLAYING COMMENTS RELATIVE TO VIDEO FRAMES USING MASKS

(71) Applicant: Shanghai Bilibili Technology Co., Ltd., Shanghai (CN)

(72) Inventor: Yuxing WANG, Shanghai (CN)

(21) Appl. No.: 16/509,310

(22) Filed: Jul. 11, 2019

(30) Foreign Application Priority Data
Jul. 17, 2018 (CN) 201810784191.3

(51) Int. Cl. H04N 21/431; H04N 21/485; H04N 21/488; H04N 21/81

(52) U.S. Cl. CPC H04N 21/4318; H04N 21/8153; H04N 21/4884; H04N 21/4854

(57) ABSTRACT

Techniques for generating at least one mask associated with displaying comments relative to video frames are described herein. The disclosed techniques include receiving data indicative of at least one vector graphic associated with a video; determining information indicative of a location of the at least one vector graphic to be presented on a frame; determining information indicative of a starting time and an ending time of the at least one vector graphic to be presented on the frame; determining at least one attribute comprising a transparency percentage of a comment to be presented relative to the frame while moving through the at least one vector graphic to be presented on the frame; generating at least one mask associated with the video based at least in part on the determined location, information, and at least one attribute; and storing the generated at least one mask.

### CROSS-REFERENCE TO RELATED APPLICATION

The present application claims priority of Chinese patent application No. 201810784191.3, filed on Jul. 17, 2018. The entire disclosure of the above-identified application is hereby incorporated by reference herein and made a part of this specification.

### BACKGROUND

Users may attempt to access conventional social media on their devices to communicate about interesting content. Using conventional social media may be cumbersome as users may have to switch back and forth between different applications to access the content of interest and social media related to the content. As communication devices, such as mobile phones, become more sophisticated, people continue to discover new ways to communicate.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 is a schematic diagram illustrating an example system that may be used in accordance with the present disclosure.

FIG. 2 is a schematic diagram illustrating an example process for combining content that may be used in accordance with the present disclosure.

FIG. 3 is a schematic diagram illustrating an example computing device that may be used in accordance with the present disclosure.

FIG. 4 is a flowchart illustrating an example process of generating at least one mask associated with a video in accordance with the present disclosure.

FIG. 5 is a schematic diagram illustrating example vector graphics in accordance with the present disclosure.

FIG. 6 is a flowchart illustrating an example process of displaying comments relative to video frames based at least in part on mask data in accordance with the present disclosure.

FIG. 7 is a screenshot illustrating an example of displaying comments relative to a video frame using masks in accordance with the present disclosure.

FIG. 8 is a screenshot illustrating an example of displaying comments relative to a video frame using masks with softened peripheries in accordance with the present disclosure.

FIG. 9 is a schematic diagram illustrating example masks having different transparency attributes in accordance with the present disclosure.

FIG. 10 is a screenshot illustrating an example of displaying comments relative to a video frame using masks having different transparency attributes in accordance with the present disclosure.

FIG. 11 is a schematic diagram illustrating example overlapping area of two masks in accordance with the present disclosure.

FIG. 12 is a screenshot illustrating an example of displaying comments relative to a video frame using masks having an overlapping area in accordance with the present disclosure.

### DETAILED DESCRIPTION OF ILLUSTRATIVE EMBODIMENTS

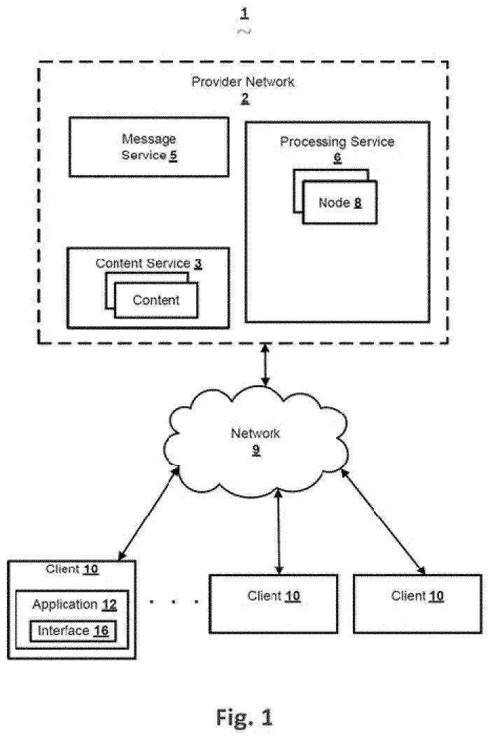

FIG. 1 is a schematic diagram showing an example system 1 that may be used in accordance with the present disclosure. The system 1 may comprise a provider network 2 and a plurality of client devices 10. The provider network 2 and the plurality of client devices 10 may communicate with each other via one or more networks 9.

In some embodiments, the content service 3 may be implemented as part of the provider network 2. In other embodiments, the content service 3 may be managed by a separate service provider than a service provider of the provider network 2. It should also be understood that the provider network 2 may provide additional content services separate from the content service 5.

The content service 3 may comprise a content streaming service, such as an Internet protocol video streaming service. The content streaming service may be configured to distribute content via a variety of transmission techniques. The content service 3 may be configured to provide the content, such as video, audio, textual data, a combination thereof, and/or the like. The content may comprise content streams (e.g., video stream, audio stream, information stream), content files (e.g., video file, audio file, text file), and/or other data. The content may comprise gaming content. For example, the content service 5 may comprise a collaborative gaming platform, a video sharing service, a video hosting platform, a content distribution platform, and/or the like.

The provider network 2 may implement a commentary service configured to allow users to comment and/or share comments associated with content. The comments may be displayed with the content on the same screen. For example, the comments may be displayed in an overlay above the content. The comments may be encoded into a format of the content. For example, the comments may be encoded as video content as the original content. The comments may be animated when displayed. For example, the comments may be shown scrolling (e.g., from right to left, left to right, top to bottom, bottom to top) across the content, which may be referred to as “bullet screens.”

The provider network 2 may be located at a data center, such as a single premise, or be distributed throughout different geographic locations (e.g., at several premises). The provider network 2 may provide the services via the one or more networks 9. The networks 9 comprise a variety of network devices, such as routers, switches, multiplexers, hubs, modems, bridges, repeaters, firewalls, proxy devices, and/or the like. The networks 9 may comprise physical links, such as coaxial cable links, twisted pair cable links, fiber optic links, a combination thereof, and/or the like. The networks 9 may comprise wireless links, such as cellular links, satellite links, Wi-Fi links and/or the like.

The provider network 2 may comprise a message service 5. The message service 5 may be configured to receive a plurality of messages. The plurality of messages may comprise a plurality of comments associated with content and information related to the plurality of comments. The plurality of messages may be associated with a particular content item, content session, and/or the like.

The message service 5 may be configured to manage messages for various content items. Users may browse content and access different content items to view comments for particular content, such as comments posted by other users for that particular content. Comments from users associated with a particular content item may be output to other users watching the particular content item. For example, all users accessing a content item (e.g., video clip) may view comments associated with the content item. Comments that are input may be output in real-time or near-real-time.

The message service 5 may be configured to process the plurality of messages. The message service 5 may implement a queue or otherwise prioritize processing of the plurality messages based on information, e.g., time stamps, incremented identifier, associated with corresponding comments. The message service 5 may be configured to process the plurality of messages using load balancing. For example, the message service 5 may be configured to use one or more of the plurality of processing nodes to process the messages, prioritize the messages, load balance the messages, and/or the like. The message service 5 may store, at least temporarily, the plurality of messages. The message service 5 may store the messages in a datastore, such as a database.

The message service 5 may be configured to process a message by performing a grouping process. The grouping process may comprise grouping messages based on a characteristic. If two messages have the same characteristic or are within a threshold range of a characteristic, then the messages may be grouped. Messages associated with a particular content item (e.g., stream, file, show, movie, song, game session) may be associated with the same group. For example, a message may comprise or be associated with a content identifier. The content identifier may uniquely identify the content item. The message service 5 may associate a message with a group associated with the content item if the content identifier is found in the message or otherwise associated with the message (e.g., sent separately).

The message service 5 may perform natural language processing, topic recognition, pattern recognition, artificial intelligence, and/or the like to automatically determine characteristics of the messages and/or group the messages. As an example, frequently occurring phrases or patterns may be identified as topics. As another example, a database of topics associated with content may be maintained. The topics may include genres (e.g., action, drama, comedy), personalities (e.g., actors, actresses, directors), languages, and/or the like. Messages may be grouped based on characteristics of the client device and/or users sending the messages. Demographics, interests, history, and/or like may be stored for a plurality of users to determine potential groupings of messages.

The message service 5 may be configured to process messages by determining contexts for outputting (e.g., displaying, presenting) comments comprised in the messages. The context may comprise a context for outputting a comment based on the grouping. The context may comprise a time context associated with a time to output the comment.

A message may indicate a time when a comment was input by a user. The time may comprise a time internal to the content item or other similar information, such as fragment identifiers. For example, the time may indicate a portion of the content item (e.g., one or more content fragments) that was viewed by a user when the user input a comment. The time may indicate when a user started inputting the comment, a duration of inputting, a time when the input was submitted, and/or the like.

The message service 5 may determine to output a comment during or close to the portion of content item being commented. In an example, if multiple messages are received for a portion of time (e.g., a scene), then a time offset may be added to some of the messages to prevent all of corresponding comments from being output at the same time.

The context may further comprise a graphical context associated with a form of the comment. The graphical context may comprise a size, a color, a font, and/or the like. The context may comprise a moving context in which the comment moves when output. The moving context may comprise an animation. For example, the moving context may comprise a direction of movement (e.g., left to right, right to left, up to down, down to up, diagonally). The moving context may comprise any type of animation, such as a spinning motion, a waving motion, a zig-zag, a circular motion, increasing in size, decreasing in size, and/or the like.

The context may be determined based on a preference associated with a message. For example, a user may specify a preference for how a corresponding comment is to be output. The user may specify the context for a particular comment. The context may be determined based on a characteristic of a particular content item. For example, the graphical context may be determined based on the background color of the content item during a particular segment. The graphical context may contrast with the background color of the content item.

The message service 5 may be further configured to process a message by generating output data. The output data may comprise instructions for implementing outputting a comment based on corresponding context. The output data may comprise application data for instructing an application to overlay the comment based on the context. The output data may comprise instructions for generating (e.g., encoding) content corresponding to a comment.

The output data may be used to generate (e.g., encode) output commentary content, such as an output content stream. The output commentary content may be combined (e.g., multiplexed) with original content item such as the content provided by the content service 3. The resulting combination may comprise content in a single package (e.g., container, transport container, transport stream). The package may comprise the original content item along with the output commentary content (e.g., displayed on top of the original content item).

The message service 5 may be further configured to process messages by performing a screening process. The screening process may comprise rejecting or flagging messages that match screening criteria. The screening criteria may specify terms and/or phrases, such as profanity, hate speech, indecent language, and/or the like. The screening criteria may specify characters, such as symbols, fonts, and/or the like. The screening criteria may specify languages, computer readable code patterns, and/or the like.

The provider network 2 may further comprise a processing service 6. The processing service 6 may be configured to provide processing for a variety of services, such as the services of the provider network 2. The processing service 6 may comprise a plurality of processing nodes 8 (e.g., as a service). The plurality of processing nodes 8 may process tasks associated with a message service 5. The plurality of processing nodes 8 may be implemented as one or more computing devices, one or more processors, one or more virtual computing instances, a combination thereof, and/or the like.

The plurality of processing nodes 8 may be implemented by one or more computing devices. The one or more computing devices may comprise virtualized computing instances. The virtualized computing instances may comprise a virtual machine, such as an emulation of a computer system, operating system, server, and/or the like. A virtual machine may be loaded by a computing device based on a virtual image and/or other data defining specific software (e.g., operating systems, specialized applications, servers) for emulation. Different virtual machines may be loaded and/or terminated on the one or more computing devices as the demand for different types of processing services changes. A hypervisor may be implemented to manage the use of different virtual machines on the same computing device.

The plurality of processing nodes 8 may comprise nodes associated with providing specific services (e.g., processing tasks). The nodes may be dedicated to providing these specific services. For example, the plurality of processing nodes 8 may implement a receiver, a content generator, a combiner, a transcoder, a combination thereof.

In some embodiments, the plurality of processing nodes 8 may process events submitted by the plurality of client computing devices. The events may be associated with discussing real-time news, videos, social hot topics, reports against certain user accounts, and/or the like. In other embodiments, the plurality of processing nodes 8 may process performance evaluation for a plurality of user account who review events in the network community. In some implementations, these services may be implemented as dedicated computing devices, dedicated processors, dedicated virtual machine instances, and/or the like. In other implementations, a variety of different nodes may implement any of the functions associated with these services.

The plurality of client devices 10 may be configured to access the content and the services of the provider network 2. The plurality of client devices 10 may comprise any type of computing device, such as a mobile device, a tablet device, laptop, a computing station, a smart device (e.g., smart apparel, smart watch, smart speaker, smart glasses), a virtual reality headset, a gaming device, a set top box, digital streaming device, robot, a vehicle terminal, a smart TV, a TV box, an e-book reader, MP3 (Moving Picture Experts Group Audio Layer III) players, MP4 (Moving Picture Experts Group Audio Layer IV) players, and so on.

The plurality of client devices 10 may be associated with one or more users. A single user may use one or more of the plurality of client devices 10 to access the provider network 2. The plurality of client devices 10 may travel to a variety of locations and use different networks to access the provider network 2.

An example client device 10 may comprise an application 12. The application 12 outputs (e.g., display, render, present) content to a user. The content may comprise videos, audio, comments, textual data and/or the like. The application 12 may also provide a menu for navigating a variety of content.

The client device 10 may access an interface 16 that allows users to provide comments associated with corresponding content and submit events to a processing service. The interface 16 may comprise an input element. For example, the input element may be configured to receive input from a user, such as comments associated with a particular content, events, user accounts, and/or the like. In some embodiments, the interface 16 may be implemented as part of the application 12.

The application 12 may allow a user to set a context (e.g., color, font size, animation, emoji, scrolling direction) associated with his or her input. The application 132 may determine (e.g., automatically) other context information, such as timing information (e.g., start time, duration, end time for the input). The application 12 may send the input, the context, the context information, and/or other information to the message service 5 of the provider network 2.

The application 12 may also send events to a processing service. As an example, the application 12 may send reports against certain users to a processing service, and the application 12 may also send reviews about the reports to the processing service. The events or reviews sent from the plurality of client computing devices comprise reasons of submitting the events, content attributes associated with the events, user account information, and/or the like. The techniques for processing events and evaluating performance of a plurality of user accounts in accordance with the present disclosure can be implemented by the example system as shown in FIG. 1.

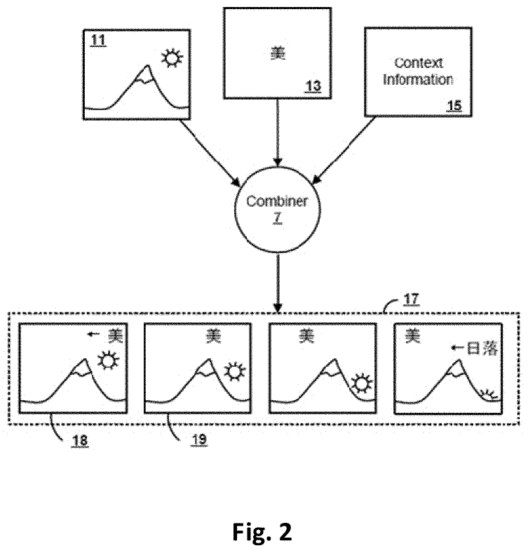

FIG. 2 is a schematic diagram showing an example process for combining content. A combiner 7 may be configured to receive content 11. As illustrated in this example, the content 11 may comprise a video. It should be understood that other content may be used. The content 11 may comprise a plurality of frames, such as a series of images. The plurality of frames may be time ordered. For example, a first frame may be ordered before a second frame.

The combiner 7 may be implemented by any of the services and/or devices described herein. For example, the combiner 7 may be implemented by the processing service 6 or the message service 5 of the provider network 2. In other examples, the combiner 7 may be implemented by the application 12 of the client devices 10.

The combiner 7 may be configured to receive message data 13 associated with the content 11. The message data 13 may comprise one or more characters. As illustrated in this example, shown in FIG. 2, a Chinese character is shown. It should be understood, that the message data 13 may comprise multiple characters, symbols, and/or like in one or more languages. For example, the message data 13 may comprise comments from users associated with the content 11.

The combiner 7 may be further configured to receive context information 15. The context information 15 may indicate a context for rendering the message data 13 associated with the content 11. The context information 15 may comprise timing information indicating a time to render the message data 13 with the content 11. The context information 15 may comprise a start time associated with the message data, a scrolling speed, a font size, a font color, an end time associated with the message data, and/or other relevant information.

The combiner 7 may be configured to combine the content 11 and the message data 13 to generate combined content 17 based on the context information 15. The combiner 7 may combine the content 11 and the message data 13 by generating a content package. The content package may comprise a container, such as a transport container (e.g., MPEG transport or other transport container), a formatted container (e.g., as specified for an encoding format). The content package may comprise instructions for a rendering engine to render the content 11 and the message data 13 at least partially together.

As shown in FIG. 2, the combiner 7 may combine the content 11 and the message data 13 by generating a modified video. For example, at least a portion of the message data may be added to the plurality of frames. The message data may be animated separately from the video and/or may be combined with (e.g., overlain, inserted into, added to, associated with, encoded into) frames of the video.

Using the content information, positions (e.g., relative to the plurality of frames) for the message data (e.g., characters) may be determined for one or more (or each) of the plurality of frames. A first position may be determined for a first frame 18. A second position may be determined for the second frame 19. The second position may be different than the first position. The second position may be determined based on the first position.

For example, a path for rendering characters of the message data may be determined. The path may specify a direction for animating and/or scrolling text above the content 11. The direction may vary. For example, the path may be curvilinear. The second position may be further along the path than the first position (e.g., if the second frame is after the first frame in the time ordering). If the path is from right to left, as shown in FIG. 2, then the second position may be further left than the first position. The combiner 7 may combine the content 11 and the message data 13 in a manner that the message data 13 is successively rendered along the path as the plurality of frames of the content progress.

Though only one character is shown, the combiner 7 may be configured to receive message data from a variety of sources at any time and combine the message data 13 with the content 11. For example, message data 13 from a plurality of users may be received and combined with the content 11. Different message data 13 may be combined in a manner that the message data 13 is rendered at least partially simultaneously.

For example, several messages from different users (e.g., another user may comment “ [symbol] ” or sunset) may be rendered at least partially at the same time with the content 11. The message data may be combined in a manner that allows for the content 11 to remain viewable during rendering of the message data. For example, the message data may be combined with the content 11 using constraints that limit the number of messages shown simultaneously, limit the location of message data (e.g., shown in areas where pixels have less change, shown in background areas of the content), and/or the like as described further herein. As an example, the message data may be shown in a background, such as the sky behind a mountain in the example of FIG. 2. In other embodiments, the message data are not received as a series of messages, but rather the messages are combined and rendered by a separate service. In such an embodiment, the messages are not separately identifiable by the combiner 7 but rather are received as, e.g., a video overlay.

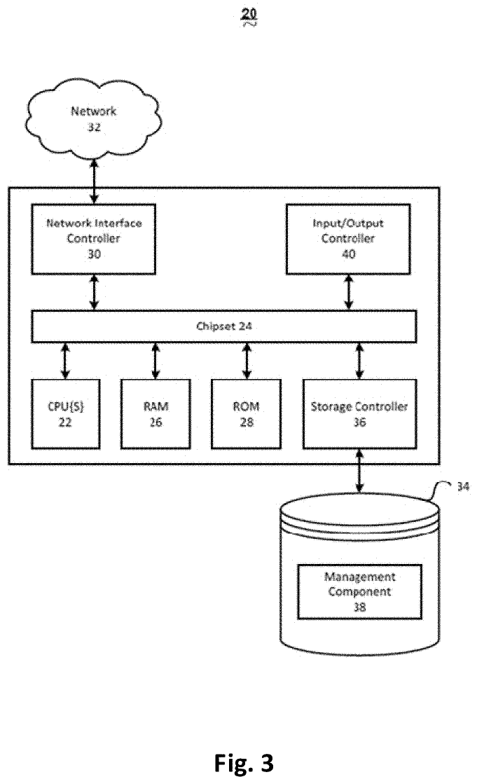

FIG. 3 depicts a computing device that may be used in various aspects, such as the services, networks, and/or clients depicted in FIG. 1. With regard to the example architecture of FIG. 1, the message service, content service, processing service, provider network, and client may each be implemented by one or more an instances of a computing device 20 of FIG. 3. The computer architecture shown in FIG. 3 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 20 may include a baseboard, or “motherboard,” which is a printed circuit board to which a multitude of components or devices may be connected by way of a system bus or other electrical communication paths. One or more central processing units (CPUs) 22 may operate in conjunction with a chipset 24. The CPU(s) 22 may be standard programmable processors that perform arithmetic and logical operations necessary for the operation of the computing device 20.

The CPU(s) 22 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 22 may be augmented with or replaced by other processing units, such as GPU(s). The GPU(s) may comprise processing units specialized for but not necessarily limited to highly parallel computations, such as graphics and other visualization-related processing.

A chipset 24 may provide an interface between the CPU(s) 22 and the remainder of the components and devices on the baseboard. The chipset 24 may provide an interface to a random access memory (RAM) 26 used as the main memory in the computing device 20. The chipset 24 may further provide an interface to a computer-readable storage medium, such as a read-only memory (ROM) 28 or non-volatile RAM (NVRAM) (not shown), for storing basic routines that may help to start up the computing device 20 and to transfer information between the various components and devices. ROM 28 or NVRAM may also store other software components necessary for the operation of the computing device 20 in accordance with the aspects described herein.

The computing device 20 may operate in a networked environment using logical connections to remote computing nodes and computer systems through local area network (LAN). The chipset 24 may include functionality for providing network connectivity through a network interface controller (NIC) 30, such as a gigabit Ethernet adapter. A NIC 30 may be capable of connecting the computing device 20 to other computing nodes over a network 32. It should be appreciated that multiple NICs 30 may be present in the computing device 20, connecting the computing device to other types of networks and remote computer systems.

The computing device 20 may be connected to a mass storage device 34 that provides non-volatile storage for the computer. The mass storage device 34 may store system programs, application programs, other program modules, and data, which have been described in greater detail herein. The mass storage device 34 may be connected to the computing device 20 through a storage controller 36 connected to the chipset 24. The mass storage device 34 may consist of one or more physical storage units. The mass storage device 34 may comprise a management component 38. A storage controller 36 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 20 may store data on the mass storage device 34 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 34 is characterized as primary or secondary storage and the like.

For example, the computing device 20 may store information to the mass storage device 34 by issuing instructions through a storage controller 36 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 20 may further read information from the mass storage device 34 by detecting the physical states or characteristics of one or more particular locations within the physical storage units.

In addition to the mass storage device 34 described above, the computing device 20 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 20.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 34 depicted in FIG. 3, may store an operating system utilized to control the operation of the computing device 20. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 34 may store other system or application programs and data utilized by the computing device 20.

The mass storage device 34 or other computer-readable storage media may also be encoded with computer-executable instructions, which, when loaded into the computing device 20, transforms the computing device from a general-purpose computing system into a special-purpose computer capable of implementing the aspects described herein. These computer-executable instructions transform the computing device 20 by specifying how the CPU(s) 22 transition between states, as described above. The computing device 20 may have access to computer-readable storage media storing computer-executable instructions, which, when executed by the computing device 20, may perform the methods described herein.

A computing device, such as the computing device 20 depicted in FIG. 3, may also include an input/output controller 40 for receiving and processing input from a number of input devices, such as a keyboard, a mouse, a touchpad, a touch screen, an electronic stylus, or other type of input device. Similarly, an input/output controller 40 may provide output to a display, such as a computer monitor, a flat-panel display, a digital projector, a printer, a plotter, or other type of output device. It will be appreciated that the computing device 20 may not include all of the components shown in FIG. 3, may include other components that are not explicitly shown in FIG. 3, or may utilize an architecture completely different than that shown in FIG. 3.

As described herein, a computing device may be a physical computing device, such as the computing device 20 of FIG. 3. A computing node may also include a virtual machine host process and one or more virtual machine instances. Computer-executable instructions may be executed by the physical hardware of a computing device indirectly through interpretation and/or execution of instructions stored and executed in the context of a virtual machine.

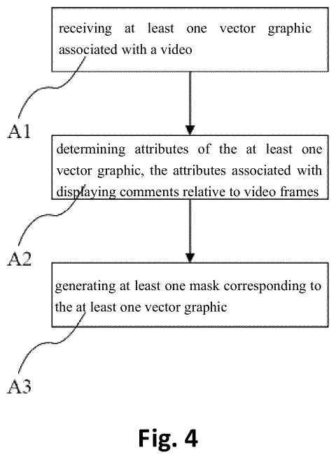

FIG. 4 is a flowchart illustrating an example process of generating at least one mask associated with a video in accordance with the present disclosure. In one embodiment, the process comprises the following steps:

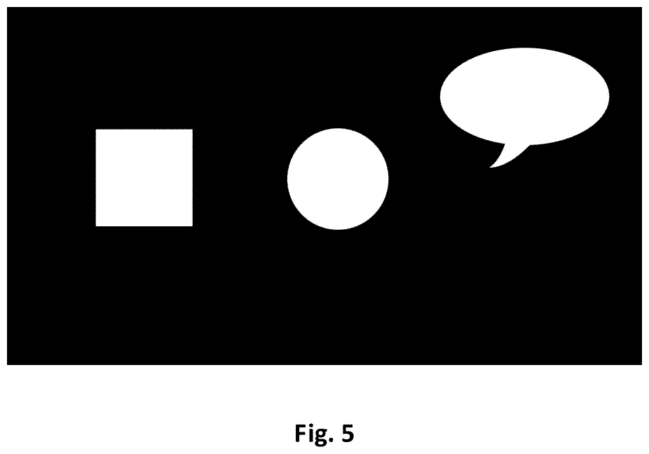

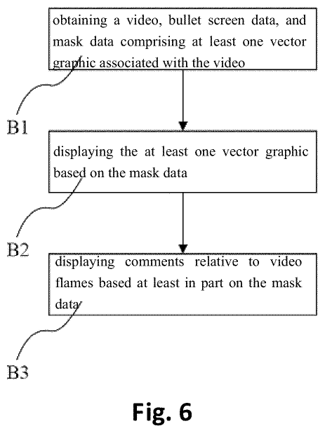

(A1) receiving at least one vector graphic associated with a video as shown in FIG. 5;

(A2) determining attributes of the at least one vector graphic, the attributes associated with displaying comments relative to video frames and determining the displaying effects of comments when they pass through the vector graphics;

(A3) generating masks associated with the video corresponding to vector graphics associated with the video.

The vector graphics associated with videos can be received from video providers (uploaders), other users (such as video viewers) or the like. In some examples, the vector graphics comprise a circle, a rectangle or a polygon with any number of sides, and the vector graphics may be drawn by video providers or viewers in a video playing area using a drawing tool.

In some embodiments, the step (A2) further comprises: determining information indicative of a location of the at least one vector graphic to be presented on a frame among the plurality of frames; determining information indicative of a starting time and an ending time of the at least one vector graphic to be presented on the frame; determining at least one attribute associated with the at least one vector graphic, wherein the at least one attribute comprises a transparency percentage of a comment on the video to be presented relative to the frame while moving through the at least one vector graphic to be presented on the frame, wherein the transparency percentage of a comment on the video to be presented relative to the frame while moving through the at least one vector graphic ranges from 0% to 100%, 100% means completely transparent, i.e. the comment is hidden completely, and wherein the at least one attribute associated with the at least one vector graphic further comprises information indicative of whether the at least one vector graphic to be presented with a softened periphery.

In other embodiments, the method further comprises the following step: repeating the steps of (A1) to (A3) to generate multiple masks or multiple mask groups associated with the video. In this case, a video can have multiple masks or mask groups for viewers to select. When multiple mask groups are generated, they may be named differently.

The present disclosure further provides a computing device of generating at least one video bullet screen mask and a computer-readable storage medium. Such computing device includes a processor and a storage, the storage is the computer-readable storage medium, on which a computer program is stored. Under the user's operations, the method as described above can be carried out when the computer program is executed by the processor.

The present disclosure further provides a method of displaying bullet screens based on the generated video bullet screen masks. In one embodiment, as shown in FIG. 3, the bullet screen playing method comprises the following steps:

(B1) obtaining a video, corresponding bullet screen data, and mask data associate with the video comprising at least one vector graphic associated with the video;

(B2) loading the mask data and displaying the at least one vector graphic based on the mask data;

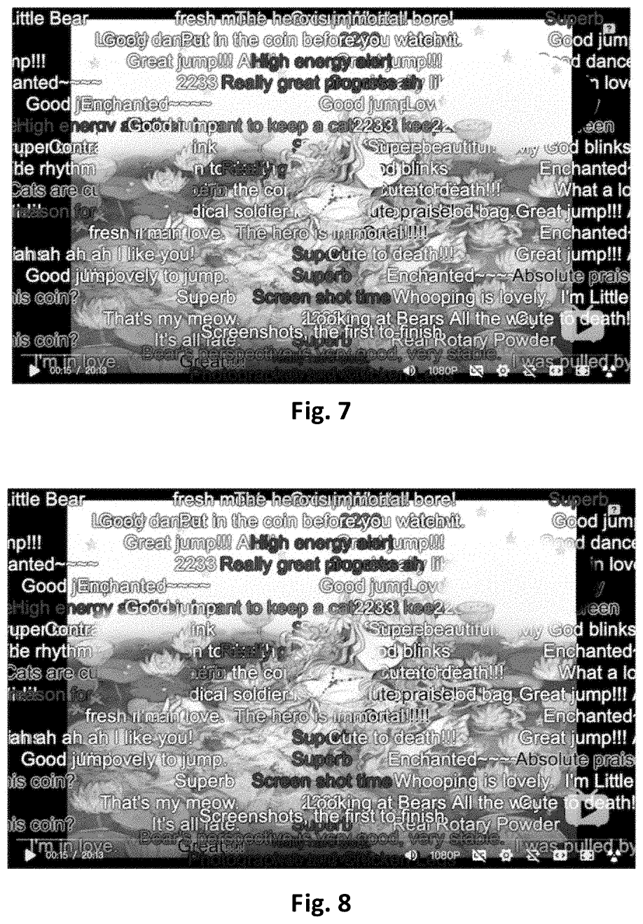

(B3) determining the displaying effects of the bullet screens when they pass through the vector graphic(s) during the playing process. FIG. 7 illustrates an example of displaying the bullet screens (i.e., comments relative to a video frame) using masks in accordance with the present disclosure. In some embodiments, a plurality of mask groups are associated with a video, and the step (B2) further includes the following steps: selecting one mask group; and loading the selected mask group and starting to play the video and the bullet screens.

In other examples, when the selected mask group comprises several overlapping vector graphics, the step (B3) further includes: determining the superimposed displaying effects by using the attributes of the several overlapping vector graphics when the bullet screens pass through the overlapping area during the playing process.

The present disclosure further provides a bullet screen playing device and a computer-readable storage medium. The bullet screen playing device includes a processor and a storage, the storage is the computer-readable storage medium, on which a computer program is stored. Under the user's instructions, the bullet screen playing method as described above is carried out when the computer program is executed by the processor.

In the practical applications, the specific implementation methods of generating video bullet screen masks and the corresponding bullet screen playing method of the present disclosure are illustrated by the following embodiments.

### Embodiment 1

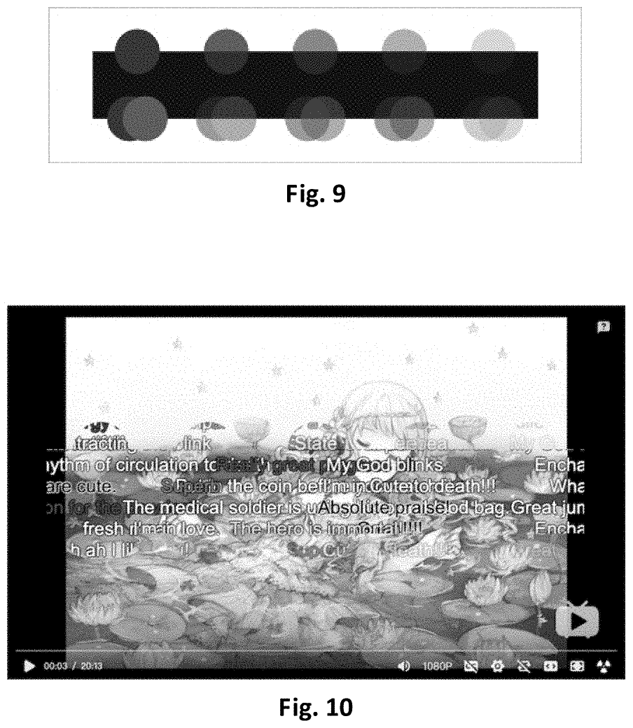

After the video uploader (UP person) uploads the video, he (or she) can choose to set one or more bullet screen masks for the video. Any bullet screen in the area of the masks has a certain transparency or completely hides. Using a mask drawing tool, a user can draw a vector graphic (a regular graphic such as rectangle, circle or the like can be drawn by a tool; an irregular graph such as polygon or the like can also be drawn by a pen tool). The location of a vector graphic may be adjusted and determined. As shown in FIG. 9, the generated masks corresponding to vector graphics may have different transparency attributes. A transparency percentage of a bullet screen to be displayed while moving through the vector graphics may be determined based on attributes associated with the vector graphics. the bullet screen transparency of each vector graphic is further set. FIG. 10 is a screenshot illustrating an example of displaying comments relative to a video frame (i.e. bullet screens) using masks having different transparency attributes.

At least one mask corresponding to at least one is generated based on determined locations, information, and attributes. The generated at least one mask associated with a video is stored for use. In some examples, a plurality of masks or mask groups associated with the video are generated and stored.

When an audience views the video, he (she) can choose to open the bullet screen masks. At this time, when the bullet screens pass through the areas of the vector graphics, the bullet screen will have certain transparent effects as shown in FIG. 10, or even are completely hidden as shown in FIG. 7 or FIG. 8, so as to ensure that the audience can see the video pictures in the mask areas.

Optionally, a video can be associated with multiple mask groups corresponding to multiple vector graphic groups, and they can be selected by the audience when there are multiple mask groups. Multiple vector graphic groups may be provided by a video uploader or provided by video viewers (especially those who have watched the video).

In addition, these mask generation methods and these bullet screen playing methods can be used not only in video contributions, but also in live video broadcasting applications. In this way, it can be guaranteed that some part of the picture of the video will not be covered by the bullet screens (or the bullet screens have transparencies), so as to make the viewing experience of the audience better.

### Embodiment 2

The difference from Embodiment 1 is that, the attributes of a vector graphic include not only the transparency, but also the appearing time and the disappearing time (not suitable for live broadcasting) of the vector graphic and that whether the periphery is softened (feathered) or not. The timing attribute can make the mask application more flexible, and the softened periphery effect is as shown in FIG. 8, it can make the displaying effect less abrupt when the mask is used.

### Embodiment 3

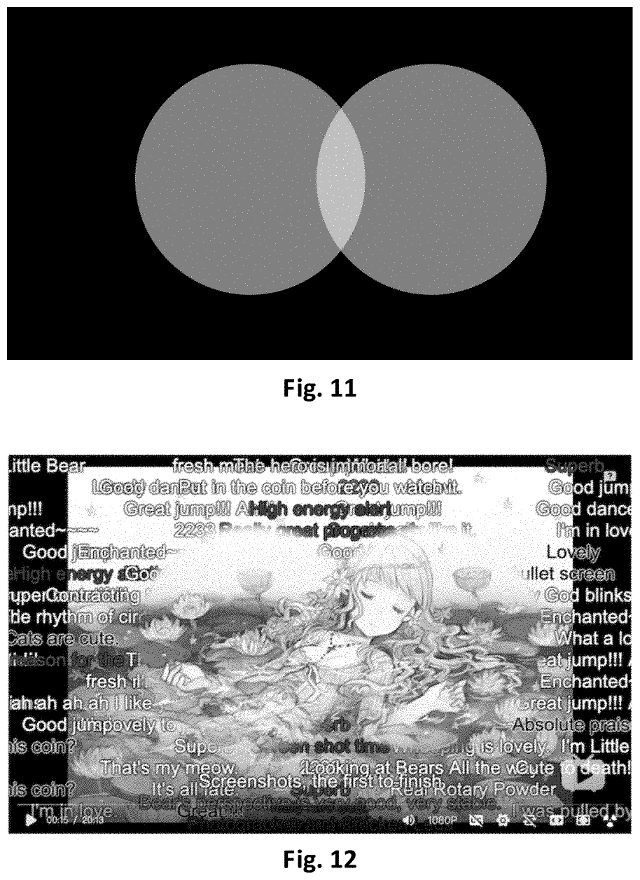

The difference from the above-described embodiments is that, when there are two or more overlapping vector graphics (positions overlap and are effective at the same time) in a mask group as shown in FIG. 11, the bullet screens passing through the overlapping area have the display effect of superimposing multiple masks as shown in FIG. 12. For example, when two masks overlap, one has a transparency of 30% and the other has a transparency of 50%, the transparency of the bullet screens passing through the overlapping area is 80%. Of course, when the added transparency is equal to or greater than 100%, the bullet screens are completely hidden.

With the video bullet screen mask generation method and the corresponding bullet screen playing method of the present disclosure, firstly, in the mask generation method, the video provider can draw and provide vector graphic(s) associated with the video, mask(s) or mask group(s) corresponding to the vector graphic(s) are generated and stored. Then, in the playing method, the mask group is loaded, and the displaying effects of the bullet screens passing through the vector graphics are determined based on received mask data. Therefore, a bullet screen playing method having interactions with video providers is provided, which enables to display the bullet screens in different regions differentially and make the bullet screens have certain transparencies or even completely hidden when they passes through the areas of the vector graphics, so as to make the video content in the areas of the vector graphics uncovered without reducing the number of bullet screens, to guarantee the viewing effects of the audiences, and ensure the experience of using the bullet screens. Moreover, the video bullet screen mask generating method, the bullet screen playing method, corresponding devices and the computer readable mediums have a simple and convenient application mode, better user experience, a wide application range and a relatively low implementation cost.

It should be noted that, the embodiments described above are illustration of the disclosure, rather than limiting the disclosure, and the technicians skilled in the art will be able to design many alternative embodiments without deviating from the scope of the appended claims. In the claims, any reference symbol placed between parentheses should not be construed as a limitation to the claims. The use of the verb “comprise” and its inflection does not exclude the existence of elements or steps other than those stated in the claims. The article “one” before the element does not exclude the existence of plural elements. The disclosure can be realized by hardware comprising several distinct components and properly programmed computers. Among the device claims enumerating several devices, some of these devices can be embodied by the same hardware. The mere fact that certain measures are stated in different depended claims does not mean that the combinations of these measures cannot be used to obtain benefits.

If desirable, the different functions discussed here can be performed in different orders and/or simultaneously with each other. In addition, if desirable, one or more of the functions described above may be optional or may be combined.

If desirable, the steps discussed above are not limited to the orders executed in the embodiments, and different steps may be executed in different orders and/or simultaneously with each other. In addition, in other embodiments, one or more of the steps described above may be optional or may be combined.

Although various aspects of the disclosure are given in the independent claims, other aspects of the disclosure include the combinations of the features from the embodiments described and/or the depended claims with the features of the independent claims, and are not just the combinations given explicitly in the claims.

It should be noted here that, although the exemplary embodiments of the disclosure have been described above, these descriptions should not be understood as the meaning of limitations. On the contrary, a number of changes and modifications may be made without departing from the scope of the disclosure as defined in the appended claims.

It should be understood by the technicians skilled in the art that, the modules in each of the devices of the embodiments of the disclosure can be implemented by at least one general computing device, the modules can be integrated in a single computing device or a network group composed of computing devices. The devices in the embodiments of the disclosure correspond to the methods in the embodiments described above, which can be implemented by executable program codes or by the combination of executable program codes and integrated circuits, therefore the disclosure is not limited to specific hardware or software or their combinations.

Please note that the above contents are only the exemplary embodiments of the disclosure and the technical principles adopted by the disclosure. It will be understood by the technicians skilled in the art that the disclosure is not limited to the specific embodiments described herein, and various obvious changes, readjustments and substitutions can be made for the technicians skilled in the art without departing from the scope of protection of the disclosure. Therefore, although the disclosure has been described in more details through the above embodiments, it is not limited to the above embodiments, and can further include more other equivalent embodiments without departing from the concept of the disclosure, and the scope of the disclosure is determined by the scope of the appended claims.

What is claimed is:

1. A computer-implemented method of generating at least one mask associated with a video, comprising:
receiving data indicative of at least one vector graphic associated with a video, the video comprising a plurality of frames;
determining information indicative of a location of the at least one vector graphic to be presented on a frame among the plurality of frames;
determining information indicative of a starting time and an ending time of the at least one vector graphic to be presented on the frame;
determining at least one attribute associated with the at least one vector graphic, wherein the at least one attribute comprises a transparency percentage of a comment on the video to be presented relative to the frame while moving through the at least one vector graphic to be presented on the frame;
generating at least one mask associated with the video, wherein the at least one mask corresponds to the at least one vector graphic and is generated based at least in part on the determined location, the determined information, and the determined at least one attribute; and
storing the at least one mask associated with the video.

2. The computer-implemented method of claim 1, wherein the at least one vector graphic comprises a circle, a rectangle, or a polygon with any number of sides.

3. The computer-implemented method of claim 1, wherein the at least one attribute associated with the at least one vector graphic further comprises information indicating whether the at least one vector graphic to be presented has a softened periphery.

4. The computer-implemented method of claim 1, wherein the at least one mask associated with the video comprises a plurality of masks associated with the video.

5. The computer-implemented method of claim 1, wherein the transparency percentage of a comment on the video to be presented relative to the frame while moving through the at least one vector graphic ranges from 0% to 100%.

6. The computer-implemented method of claim 1, wherein the at least one vector graphic is received from a video provider who provides the video.

7. A computing system of generating at least one mask associated with a video, comprising:
at least one processor; and
at least one memory communicatively coupled to the at least one processor and storing instructions that upon execution by the at least one processor cause the computing system to:
receive data indicative of at least one vector graphic associated with a video, the video comprising a plurality of frames;
determine information indicative of a location of the at least one vector graphic to be presented on a frame among the plurality of frames;
determine information indicative of a starting time and an ending time of the at least one vector graphic to be presented on the frame;
determine at least one attribute associated with the at least one vector graphic, wherein the at least one attribute comprises a transparency percentage of a comment on the video to be presented relative to the frame while moving through the at least one vector graphic to be presented on the frame;
generate at least one mask associated with the video, wherein the at least one mask corresponds to the at least one vector graphic and is generated based at least in part on the determined location, the determined information, and the determined at least one attribute; and
store the at least one mask associated with the video.

8. The computing system of claim 7, wherein the at least one vector graphic comprises a circle, a rectangle, or a polygon with any number of sides.

9. The computing system of claim 7, wherein the at least one attribute associated with the at least one vector graphic further comprises information indicative of whether indicating whether the at least one vector graphic to be presented has a softened periphery.

10. The computing system of claim 7, wherein the at least one mask associated with the video comprises a plurality of masks associated with the video.

11. The computing system of claim 7, wherein the transparency percentage of a comment on the video to be presented relative to the frame while moving through the at least one vector graphic ranges from 0% to 100%.

12. The computing system of claim 7, wherein the at least one vector graphic is received from a video provider who provides the video.

13. A computing system of displaying comments relative to video frames using at least one mask associated with a video, comprising:
at least one processor; and
at least one memory communicatively coupled to the at least one processor and storing instructions that upon execution by the at least one processor cause the computing system to:
receive a video comprising a plurality of frames;
receive bullet screen data comprising a plurality of comments on the video;
receive mask data comprising at least one vector graphic associated with the video, wherein the mask data further comprise information indicative of a location of the at least one vector graphic to be displayed on a frame among the plurality of frames, information indicative of a starting time and an ending time of the at least one vector graphic to be presented on the frame, and at least one attribute associated with the at least one vector graphic comprising a transparency percentage of a comment among the plurality of the comments to be displayed relative to the frame while moving through the at least one vector graphic to be display on the frame;
display the at least one vector graphic on the frame based on the mask data; and
display the comment relative to the frame based at least in part on the at least one attribute associated with the at least one vector graphic.

14. The computing system of claim 13, wherein the mask data comprise a plurality of vector graphics associated with the video.

15. The computing system of claim 14, the at least one memory further storing instructions that upon execution by the at least one processor cause the computing system to:
determine a transparency percentage of a comment among the plurality of comments to be displayed in an overlapping area of at least two vector graphics among the plurality of vector graphics based on attributes associated with the at least two vector graphics.

16. The computing system of claim 13, wherein the at least one vector graphic comprises a circle, a rectangle, or a polygon with any number of sides.

17. The computing system of claim 13, wherein at least one attribute associated with the at least one vector graphic further comprises information indicating whether the at least one vector graphic to be presented has a softened periphery.

18. The computing system of claim 13, wherein the transparency percentage of a comment on the video to be presented relative to the frame while moving through the at least one vector graphic ranges from 0% to 100%.

19. The computing system of claim 13, wherein the at least one vector graphic is received from a video provider who provides the video.
